(19) United States
(12) Patent Application Publication
(10) Pub. No.: US 2006/0009215 A1
(43) Pub. Date: Jan. 12, 2006

(54) Storing data content in a remote computer

(75) Inventors: Leonid Bogod, Helsinki (FI); Markku Oksanen, Helsinki (FI); Marko Karhiniemi, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 11/140,572

(22) Filed: May 27, 2005

(30) Foreign Application Priority Data
May 27, 2004 (FI) 20040727

(51) Int. Cl. H04Q 7/20

(52) U.S. Cl. 455/433

(57) ABSTRACT

A method, system, devices and computer programs for storing data content from a data communication network in a remote computer are shown. In the method data provided by a data content server of a data communication network is browsed using a mobile terminal. A link to data content which may be provided by the data content server is selected. Furthermore, a remote computer connected to the data communication network is selected with the mobile terminal as a destination device for storing the selected data content. Finally, the selected data content is stored in the selected remote computer.

### BACKGROUND OF THE INVENTION

1. Field of the Invention

The invention relates to communication networks. In particular, the invention relates to a novel and improved method, system, devices and computer programs for storing data content in a remote computer using a mobile terminal.

2. Description of the Related Art

Mobile terminals, e.g. mobile phones, Personal Digital Assistants (PDA) etc. can be used to browse the Internet. The content browsed by the mobile terminal may be visually customized for mobile terminals or the content may be the same as browsed using a computer.

When browsing data content on the Internet using a mobile terminal, one may often want to store a file containing e.g. a picture, sound, a video clip etc. in a memory. A mobile terminal typically has limited resources for downloading and storing content for later consumption. Limited resources refer e.g. to limited memory space of the mobile terminal and bandwidth of the network connection. If a large file were downloaded with a mobile terminal, it would be apparent that it would take a while to download the file using a low speed network connection thus causing relatively high costs to the user of the mobile terminal.

Furthermore, although a mobile terminal had enough memory space and network bandwidth for downloading it might not have all the needed software to run the downloaded file.

Storing mail attachments and other big files directly to a home or office personal computer enhances usability. Mobile terminal initiated attachment storing can be done currently with appropriate software. This can be done e.g. with a telnet or secure shell client from a mobile terminal or with remote-use software as a virtual networking client. However, these solutions are not convenient for frequent use. Furthermore, these solutions are not user-friendly and require additional knowledge and custom software in order to work appropriately.

Naturally it is possible that a user downloads a desired file afterwards using e.g. his/her home computer. In this solution, however, the user must remember the page address or send the address to the home computer while using a mobile terminal for browsing.

Some service providers offer a service in which data content (e.g. a file) can be sent to an email address of the user of the mobile terminal. This solution, however, requires a separate email service to the web page in question.

In summary, mobile browsing and browsers suffer from a serious shortcoming: since the mobile terminal lacks both bandwidth to communication networks and adequate storage, downloading of large files may not be possible.

Therefore, there is a need for a solution providing an easy and user-friendly solution to the aforementioned problems.

### SUMMARY OF THE INVENTION

The invention relates to a solution that enables a mobile terminal to store data content from a data content server connected to a data communication network in a remote computer.

According to one aspect of the invention there is provided a method of storing data content from a data communication network in a remote computer. The method comprises browsing data provided by a data content server of the data communication network using a mobile terminal, sending at least one data request associated with data content to the data content server, selecting with the mobile terminal a remote computer connected to the data communication network as a destination device for storing the data content, and storing the data content in the remote computer.

In one embodiment of the method, the method further comprises storing in a memory of the mobile terminal at least one data request associated with data content, sending at least one data request stored in the memory of the mobile terminal to the selected remote computer, sending from the remote computer at least one data request to the data content server, sending from the data content server a requested data content to the remote computer and storing the data content in the remote computer.

In another embodiment of the method, the method further comprises setting up an association between the mobile terminal and the remote computer, browsing data provided by the data content server of the data communication network using the mobile terminal via the remote computer using the set up association, sending at least one data request from the mobile terminal via the remote computer to the data content server, sending at least one data request response from the data content server to the mobile terminal via the remote computer, receiving with the remote computer a command from the mobile terminal, the command indicating that data content is to be stored in the remote computer, sending with the remote computer data content request to the data content server, sending the data content from the data content server to the remote computer, and storing the data content in the remote computer.

According to another aspect of the invention there is provided a system of storing data content from a data communication network in a remote computer. The system comprises a data communication network, a wireless communication network connected to the data communication network, a data content server connected to the data communication network, a mobile terminal connected to the wireless communication network, wherein the mobile terminal comprises browsing means configured to browse data provided by the data content server and a remote computer connected to the data communication network. The system further comprises at least one network device configured to send at least one data request associated with data content to the data content server. Furthermore, the browsing means are configured to select the remote computer connected to the data communication network as a destination device for storing the data content and the remote computer is configured to store the data content from the data content server.

In one embodiment of the system, the browsing means are configured to send at least one data request associated with data content to the data content server, the mobile terminal comprises a first memory configured to store at least one data request associated with the data content, the browsing means are configured to send at least one data request stored in the first memory to the selected remote computer, the remote computer comprises a remote proxy application configured to receive the at least one data request from the mobile terminal, to send at least one data request to the data content server, and to receive a requested data content from the data content server, and the remote computer comprises a second memory configured to store the data content.

In another embodiment of the system, the system further comprises a connection application configured to set up an association between the mobile terminal and the remote computer, the browsing means are configured to browse data provided by the data content server using the set up association, the browsing means are configured to send at least one data request to the data server via a remote proxy application of the remote computer, the remote proxy application is configured to send at least one data request response from the data content server to the mobile terminal, to receive a command from the browsing means, the command indicating that data content is to be stored in the remote computer, to send a data content request to the data content server, and to receive the requested data content from the data content server, and the remote computer comprises a second memory configured to store the data content.

According to another aspect of the invention there is provided a computer program for storing data content from a data communication network in a remote computer. The computer program comprises code adapted to perform the following steps when executed on a data-processing device: browsing data provided by a data content server of the data communication network using a mobile terminal, storing in a memory of the mobile terminal at least one data request associated with data content, selecting with the mobile terminal a remote computer connected to the data communication network as a destination device for storing the data content, and sending at least one data request stored in the memory of the mobile terminal to the selected remote computer.

According to another aspect of the invention there is provided a computer program for storing data content from a data communication network in a remote computer. The computer program comprises code adapted to perform the following steps when executed on a data-processing device: setting up an association between a mobile terminal and the remote computer, browsing data provided by a data content server of the data communication network using the mobile terminal via the remote computer using the set up association, sending at least one data request from the mobile terminal to the remote computer, receiving at least one data request response from the remote computer, and sending a command from the mobile terminal to the remote computer, the command indicating that data content is to be stored in the remote computer.

According to another aspect of the invention there is provided a computer program for storing data content from a data communication network in a remote computer. The computer program comprises code adapted to perform the following steps when executed on a data-processing device: setting up an association between a mobile terminal and the remote computer, receiving at least one data request from the mobile terminal with the remote computer, sending from the remote computer at least one data request to the data content server, receiving a requested data content from the data content server with the remote computer, and storing the data content in the remote computer.

According to another aspect of the invention there is provided a computer program for storing data content from a data communication network in a remote computer. The computer program comprises code adapted to perform the following steps when executed on a data-processing device: setting up an association between a mobile terminal and the remote computer, receiving at least one data request from the mobile terminal with the remote computer, sending the at least one data request to a data content server, receiving at least one data request response from the data content server with the remote computer, sending the at least one data request response to the mobile terminal from the remote computer, receiving with the remote computer a command from the mobile terminal, the command indicating that data content is to be stored in the remote computer, sending with the remote computer a data content request to the data content server, and storing the data content in the remote computer.

According to another aspect of the invention there is provided a mobile terminal for storing data content from a data communication network in a remote computer, comprising browsing means configured to browse information provided by a data content server, wherein the browsing means are configured to send at least one data request associated with data content to the data content server and to receive at least one data request response from the data content server. The mobile further comprises a first memory configured to store at least one data request associated with data content. The browsing means are configured to select the remote computer as a destination device for storing the data content and to send at least one data request stored in the first memory to the selected remote computer.

According to another aspect of the invention there is provided a mobile terminal of storing data content from a data communication network in a remote computer, comprising browsing means configured to browse information provided by a data content server. The mobile terminal further comprises a connection application configured to set up an association between the mobile terminal and the remote computer. The browsing means are configured to browse data provided by the data content server via a remote proxy application of the remote computer by using the set up association, to send at least one data request to the remote computer, to receive at least one data request response from the remote computer, and to send a command to the remote computer, the command indicating that data content is to be stored in the remote computer.

According to another aspect of the invention there is provided a remote computer for storing data content from a data communication network. The remote computer comprises a connection application configured to set up an association between a mobile terminal and the remote computer, a remote proxy application configured to receive at least one data request from the mobile terminal, to send at least one data request to a data content server, to receive a requested data content from the data content server, and a second memory configured to store the data content.

According to another aspect of the invention there is provided a remote computer for storing data content from a data communication network. The remote computer comprises a connection application configured to set up an association between a mobile terminal and the remote computer, a remote proxy application configured to receive at least one data request from the mobile terminal, to send the at least one data request to a data content server, to receive at least one data request response from the data content server, to send the at least one data request response to the mobile terminal, to receive a command from the mobile terminal, the command indicating that data content is to be stored in the remote computer, to send a data content request to the data content server, and to receive the data content from the data content server, and a second memory configured to store the data content from the data content server.

Further embodiments of the invention are disclosed below.

The invention has several advantages over the prior-art solutions. The invention enables a user of a mobile terminal to store data content (i.e. any form of downloadable file) from a data content server connected to a data communication network in a remote computer, e.g. a home computer or an office computer.

A further benefit of the invention is that it provides a user-friendly way to store files (links) encountered while browsing with a mobile terminal to a remote computer. The storing procedure to the user does not differ from the procedure when a file is stored locally.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a flow diagram illustrating one embodiment of a method according to the invention,

FIG. 2 is a flow diagram illustrating another embodiment of a method according to the invention,

FIG. 3 is a block diagram illustrating one embodiment of a mobile terminal and a remote computer according to the invention, and

FIG. 4 is a block diagram illustrating one embodiment of a system according to the invention.

### DETAILED DESCRIPTION OF THE PREFERRED EMBODIMENTS

Reference will now be made in detail to the embodiments of the invention, examples of which are illustrated in the accompanying drawings.

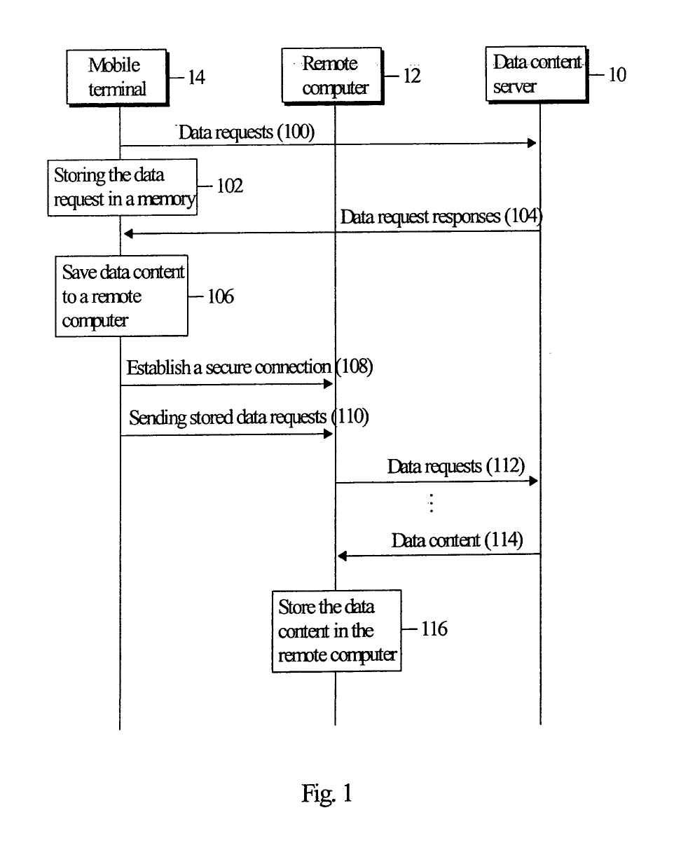

FIG. 1 discloses one embodiment of a method of storing data content in a remote computer according to the invention. FIG. 1 is a simplified example and therefore an actual system may comprise additional network elements.

FIG. 1 comprises three main entities: a mobile terminal 14, a remote computer 12 and a data content server 10. The entities are connected to each other via one or more communication networks, e.g. wireless data communication networks and data communication networks. Mobile terminal 14 is e.g. a mobile phone or a personal digital assistant (PDA). Mobile terminal 14 comprises a mobile browser with which a user of mobile terminal 14 is able to browse e.g. the Internet. In this embodiment, mobile terminal 14 browses the Internet directly or via a computer or a proxy that is not remote computer 12.

When mobile terminal 14 browses e.g. the Internet, the browsing generates a plurality of data requests that are sent to data content server 10, step 100. Sophisticated web pages may require the user e.g. to log in to a web page, select one or more links, fill in a plurality of fields in order to get a customized web page and in order to be able to download a desired file. Therefore, if such a file was to be downloaded at some point into remote computer 12, e.g. home or office computer, remote computer 12 should imitate the aforementioned selection sequence in order to be able to download the file. Therefore, there has to be a way for mobile terminal 14 to transmit the selection sequence to remote computer 12.

Therefore, mobile terminal 14 caches in a memory of mobile terminal 14 at least one data request associated with data content, step 102. The expression ‘associated with data content’ refers to data requests that have to be made in order to be able to download a desired data content, e.g. a media file etc. Data content server 10 sends responses to the data requests sent by mobile terminal 14, step 104.

When the user of mobile terminal 14 finds data content he/she is willing to save to a remote computer, the user chooses remote computer 12 as a destination device for storing the data content, step 106. The choosing can be made e.g. via a conventional ‘save as’ dialog box or with any other appropriate way. In response to choosing remote computer 12 as a destination device for storing the data content, mobile terminal 14 establishes a connection with remote computer 12, step 108. The connection refers e.g. to a Secure Socket Layer (SSL) or to a Virtual Private Network (VPN) tunnel.

After establishing the connection with remote computer 12, mobile terminal 14 sends at least one data request stored in the memory of mobile terminal 14 to remote computer 12, step 110. The at least one data request may refer to only one data request, e.g. to a direct link to the desired file. In another embodiment, the at least one data request comprises at least one of the following: login information, a direct link to the data content, information associated with at least one data field, selection information and information identifying a communication protocol. The communication protocol is e.g. the Hypertext Transfer Protocol (HTTP), the Hypertext Transfer Protocol over Secure Socket Layer (HTTPS), the File Transfer Protocol (FTP) or any other communication protocol. Based on the at least one data request received from mobile terminal 14 a remote proxy application of remote computer 12 is able to download a desired data content from data content server 10. Therefore, the remote proxy application of remote computer 12 sends the received at least one data request to data content server 10, step 112.

In response to the at least one data request, data content server 10 sends the desired data content to remote computer 10, step 114. Remote computer 12 stores the data content in a memory, step 116.

The remote proxy application (proxy server) acts as an intermediary between a client application and a data content server. It intercepts all the requests sent by a browser and tries to fulfill them by itself. This is, that proxy sends the requested information (html content, pictures, files) from its cache if it exists there. Otherwise it forwards the requests further to the web server. Basic functionality of the proxy server is similar to a normal proxy for caching content, supporting e.g. the Hyper-Text Transfer Protocol (HTTP), Secure Socket Layer (SSL), Post Office Protocol (POP), Simple Mail Transfer Protocol (SMTP) and File Transfer Protocol (FTP) protocols. However, the proxy server is also aware of the directory structure (may be a restricted sandbox in order to enhance security), and supports intercepting a file from an Internet server and storing it in a certain mobile terminal user-defined directory. Correspondingly, it is also possible to upload files from the proxy server.

In one embodiment of FIG. 1, the connection between mobile terminal 14 and remote computer 12 has been established earlier than in step 108. The established connection may be in idle state while the user browses the Internet using mobile terminal 14. When the user wishes to save data content to remote computer 12, the established connection becomes active again.

In another embodiment of FIG. 1, it may not be necessary to store data requests in the memory of mobile terminal 14, as indicated at step 102. In this case, at step 110, mobile terminal 14 sends to remote computer 110 only a direct link (a data request) to a desired data content.

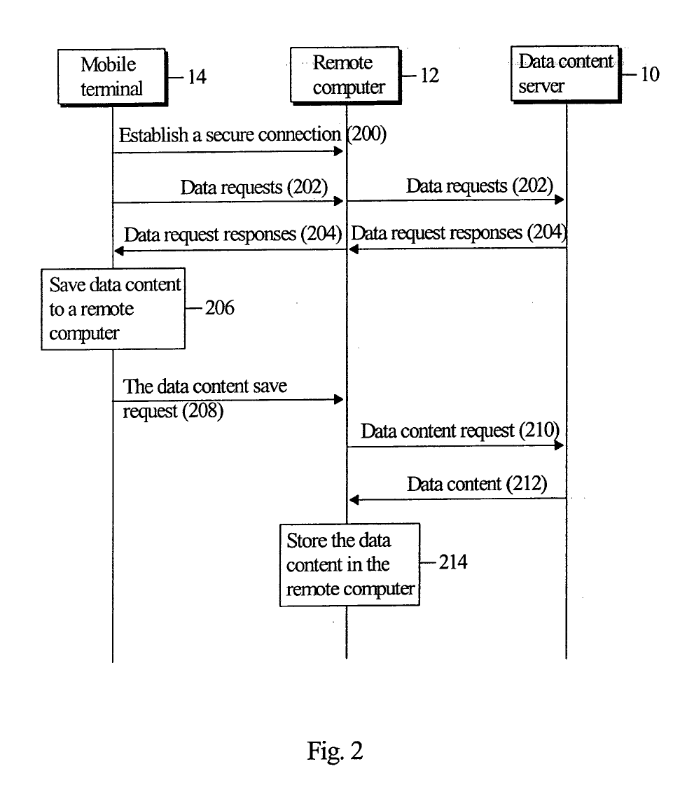

FIG. 2 discloses another embodiment of a method of storing data content in a remote computer according to the invention. FIG. 2 is a simplified example and therefore an actual system may comprise additional network elements.

FIG. 2 comprises three main entities: a mobile terminal 14, a remote computer 12 and a data content server 10. The entities are connected to each other via one or more communication networks, e.g. wireless data communication networks and data communication networks. Mobile terminal 14 is e.g. a mobile phone or a personal digital assistant (PDA). Mobile terminal 14 comprises a mobile browser with which a user of mobile terminal 14 is able to browse e.g. the Internet. In this embodiment, mobile terminal 14 browses the Internet via a remote proxy application provided by remote computer 12.

The remote proxy application (proxy server) acts as an intermediary between a client application and a data content server. It intercepts all the requests sent by a browser and tries to fulfill them by itself. This is, that proxy sends the requested information (html content, pictures, files) from its cache if it exists there. Otherwise it forwards the requests further to the web server. Basic functionality of the proxy server is similar to a normal proxy for caching content, supporting e.g. the Hyper-Text Transfer Protocol (HTTP), Secure Socket Layer (SSL), Post Office Protocol (POP), Simple Mail Transfer Protocol (SMTP) and File Transfer Protocol (FTP) protocols. However, the proxy server is also aware of the directory structure (may be a restricted sandbox in order to enhance security), and supports intercepting a file from an Internet server and storing it in a certain mobile terminal user-defined directory. Correspondingly, it is also possible to upload files from the proxy server.

Mobile terminal 14 establishes a connection with remote computer 12, step 200. The connection refers e.g. to a Secure Socket Layer (SSL) or to a Virtual Private Network (VPN) tunnel. After establishing the connection with remote computer 12, mobile terminal 14 is able to browse the Internet via the remote proxy application provided by remote computer 12, therefore sending at least one data request via the remote proxy application to data content server 10, step 202. In response to the at least one data request, data content server 10 sends corresponding data request responses to mobile terminal 14 via the remote proxy application of remote computer 12, step 204.

When the user of mobile terminal 14 finds data content he/she is willing to save to a remote computer, the user chooses remote computer 12 as a destination device for storing the data content, step 206. The choosing can be made e.g. via a conventional ‘save as’ dialog box or with any other appropriate way. In response to choosing remote computer 12 as a destination device for storing the data content, mobile terminal 14 sends a data content save request to remote computer 12, step 208, via the previously established connection between mobile terminal 14 and remote computer 12.

Based on the data request received from mobile terminal 14 remote computer 12 is able to download a desired data content from data content server 10. Therefore, remote computer 12 sends a data request to data content server 10, step 210. In response to the data request, data content server 10 sends the requested data content to remote computer 12. Remote computer 12 stores the data content in a memory, step 214.

In one embodiment of FIG. 2, remote computer 12 identifies at step 208 that the data content save request is a remote storing request. In response to the identification, remote computer 12 changes the data request (e.g. adds an additional identifier to the request) received from mobile terminal 14 at step 208 so that it is able to identify the data content response sent by data content server 10 at step 212.

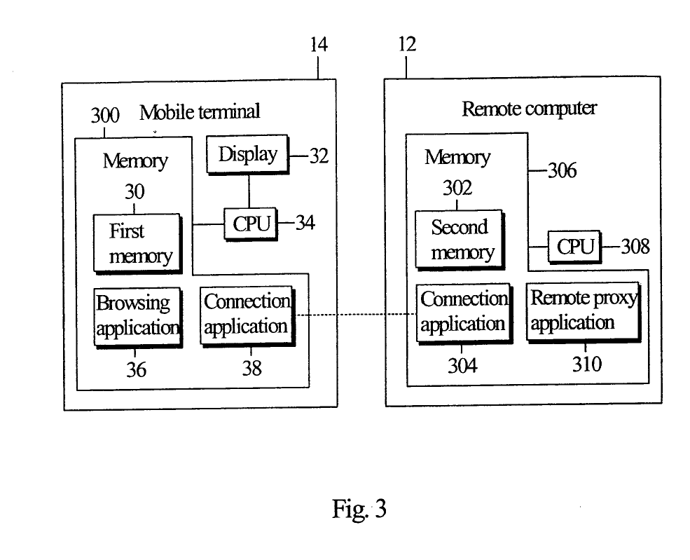

FIG. 3 discloses one embodiment of a mobile terminal 14 and a remote computer 12 according to the invention. Mobile terminal 14 is e.g. a mobile phone, a personal digital assistant (PDA) or an equivalent mobile terminal having limited storing capabilities. Each device is connected to a data communication network, e.g. the Internet, either directly or via another communication network, e.g. a wireless communication network.

Mobile terminal 14 comprises a central processing unit 30 to which a display 32 and a memory 300 are connected. It must be noted that mobile terminal 14 may comprise also several additional hardware and software elements and components that are not shown in FIG. 3. Memory 300 comprises also browsing means 36, e.g. a browsing application or a browser, that can be used to browse together with display 32 data content e.g. from the Internet. Browsing application 36 is configured to send at least one data request either directly to a data content server or to remote computer 12. Furthermore, memory 300 comprises a first memory 30 configured to store at least one data request associated with data content and a connection application 38 configured to establish a connection with remote computer 12. It is evident that mobile terminal 14 comprises also several hardware and software components with which mobile terminal 14 is able to connect to one or more communication networks.

Remote computer 12 comprises a central processing unit 308 and a memory 306 connected to central processing unit 308. Memory 306 comprises a second memory 302 and a connection application 304 configured to establish a connection with mobile terminal 14. The connection refers e.g. to a Secure Socket Layer (SSL) or to a Virtual Private Network (VPN) tunnel. Furthermore, memory 306 comprises a remote proxy application 310 configured to receive at least one data request from mobile terminal 14, to send at least one data request to a data content server and to receive a requested data content from the data content server. Second memory 302 is configured to store the received data content.

Remote proxy application 310 (proxy server) acts as an intermediary between a client application and a data content server. It intercepts all the requests sent by a browser and tries to fulfill them by itself. This is, that proxy sends the requested information (html content, pictures, files) from its cache if it exists there. Otherwise it forwards the requests further to the web server. Basic functionality of the proxy server is similar to a normal proxy for caching content, supporting e.g. the Hyper-Text Transfer Protocol (HTTP), Secure Socket Layer (SSL), Post Office Protocol (POP), Simple Mail Transfer Protocol (SMTP) and File Transfer Protocol (FTP) protocols. However, the proxy server is also aware of the directory structure (may be a restricted sandbox in order to enhance security), and supports intercepting a file from an Internet server and storing it in a certain mobile terminal user-defined directory. Correspondingly, it is also possible to upload files from the proxy server.

It is evident that remote computer 12 comprises also several hardware and software components with which remote computer 12 is able to connect to one or more communication networks or network elements. Furthermore, it must be noted that remote computer 12 may comprise also several additional hardware and software elements and components that are not shown in FIG. 3.

In one embodiment of FIG. 3, first memory 30 of mobile terminal 14 is configured to store at least one data request associated with data content. The storing of data requests was disclosed in more detail in FIG. 1. Mobile terminal 14 stores in first memory 300 data requests associated with data content sent to a data content server. The expression ‘associated with data content’ refers to data requests that have to be made in order to be able to download a desired data content, e.g. a media file etc. The data requests stored in first memory 30 may comprise at least one of the following: login information, a direct link to the data content, information associated with at least one data field, selection information and information identifying a communication protocol.

Browsing application 36 is configured to select a remote computer as a destination device for storing the data content and to send at least one data request stored in first memory 30 to remote computer 12. Connection application 38 is configured to set up an association between mobile terminal 14 and remote computer 12. The connection refers e.g. to a Secure Socket Layer (SSL) or to a Virtual Private Network (VPN) tunnel. Browsing application 36 is configured to send at least one data request to remote computer 12 using the set up association.

In one embodiment, connection application 38 is configured to set up the connection between mobile terminal 14 and remote computer 12, when browsing application 36 is used to select remote computer 12 as a destination device for storing the data content. In another embodiment, connection application 38 is configured to set up the connection between mobile terminal 14 and remote computer 12 earlier, prior to selecting remote computer 12 as a destination device for storing the data content.

Remote proxy application 310 of remote server 12 is configured to receive the data requests sent by mobile terminal 14. Remote proxy application 310 is further configured to send the data requests to the data content server in order to receive a requested data content from the data content server.

In another embodiment of FIG. 3, mobile terminal 14 browses the Internet via remote proxy application 310 provided by remote computer 12. Therefore, connection application 38 of the mobile terminal is configured to establish a connection with the remote computer 12 right at the beginning of the browsing. The connection refers e.g. to a Secure Socket Layer (SSL) or to a Virtual Private Network (VPN) tunnel. Browsing application 36 is configured to browse data provided by a data content server via remote proxy application 310 of remote computer 12 by using the set up association. Furthermore, browsing application 36 is configured to send at least one data request to the data content server via remote computer 12. In this embodiment, browsing application 36 is also configured to send a command, e.g. a data request, to remote computer 12, the command indicating that data content is to be stored in remote computer 12. The data requests sent to remote terminal comprise e.g. at least one of the following: login information, a direct link to the data content, information associated with at least one data field, selection information and information identifying a communication protocol.

Because in this embodiment browsing is performed via remote proxy application 310, remote proxy application 310 is configured to receive data requests from mobile terminal 14, to send data requests further to the data content server, to receive data request responses from the data content server and to send the data request responses back to mobile terminal 14. Remote proxy application 310 is further configured to receive a command from mobile terminal 14, the command indicating that data content is to be stored in remote computer 12. In response to the command, remote proxy application 310 is configured to send a data content request to the data content server. The requested data content is stored in second memory 302. In one embodiment, remote proxy application 310 is configured to change the data request (command) sent by mobile terminal 14 in order to store the data content in the second memory 302. For example, remote proxy application 310 adds an additional identifier to the data content request (command) received from mobile terminal 14 so that it is able to identify the data content response sent by the data content server.

Remote proxy application 310 (proxy server) in remote computer 12 may be configured remotely from the mobile terminal. This can be done with a proprietary protocol or it can be a simpler http-based configuration. In the proxy server it is possible to do real time content conversion that is e.g. extraction of big images or converting images to smaller ones or re-encoding a video stream.

FIG. 3 discloses single memories 300 and 306 in mobile terminal 14 and remote computer 12. Memory 300, 306 may refer to a single memory or memory area or to a plurality memories or memory areas that may include e.g. random access memories (RAM), read-only memories (ROM) etc. Memory 300, 306 may also include other applications or software components that are not described in more detail and also may include the computer program (or portion thereof), which when executed on central processing unit 34, 308 performs at least some of the steps disclosed in the invention. Central processing unit 34, 308 may also include memory or a memory may be associated therewith which may include a computer program (or portion thereof) which when executed on central processing unit 34, 308 performs at least some of the steps disclosed in the invention.

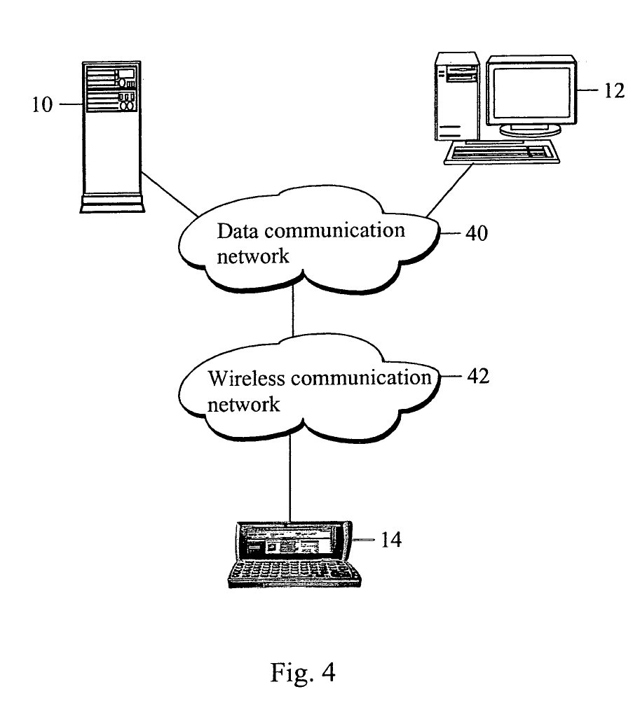

FIG. 4 discloses a simplified example of a system according to the invention. The system comprises a mobile terminal 14, a remote computer 12 and a data content server 10. Mobile terminal 14 is e.g. a mobile phone, a personal digital assistant (PDA) etc. Data content server 10 is connected to remote computer 12 via a data communication network 40, e.g. the Internet.

Mobile terminal 14 is connected to a wireless communication network 42 that comprises e.g. at least one of a Global System for Wireless communications (GSM) network, a General Packet Radio Service (GPRS) network, a Wideband Code Division Multiple Access (WCDMA) network, a wireless access network, e.g. a Wiress Local Area Network (WLAN), a Personal Area Network (PAN) etc. Wireless communication network 42 is further connected to data communication network 40.

It will be evident to any person skilled in the art that with the advancement of technology, the basic idea of the invention may be implemented in various ways. The invention and its embodiments are thus not limited to the examples described above, instead they may vary within the scope of the claims.

1. A method of storing data content from a data communication network in a remote computer,
characterized in that the method comprises:
browsing data provided by a data content server of the data communication network using a mobile terminal;
sending at least one data request associated with data content to the data content server;
selecting with the mobile terminal a remote computer connected to the data communication network as a destination device for storing the data content; and
storing the data content in the remote computer.

2. A method according to claim 1, characterized in that the method further comprises:
storing in a memory of the mobile terminal at least one data request associated with data content;
sending at least one data request stored in the memory of the mobile terminal to the selected remote computer;
sending from the remote computer at least one data request to the data content server;
sending from the data content server a requested data content to the remote computer; and
storing the data content in the remote computer.

3. The method according to claim 2, characterized in that the method further comprises:
setting up an association between the mobile terminal and the remote computer; and
sending with the mobile terminal the at least one data request to the remote computer using the set up association.

4. The method according to claim 3, characterized in that the method comprises:
setting up the association between the mobile terminal and the remote computer, when selecting the remote computer with the mobile terminal.

5. The method according to claim 3, characterized in that the step of setting up the association comprises setting up the association between the mobile terminal and the remote computer using a secure link protocol.

6. The method according to claim 2, characterized in that the method further comprises:
changing at least one data request sent by the mobile terminal in the remote computer in order to store the data content in the remote computer.

7. The method according to claim 2, characterized in that the step of storing in a memory of the mobile terminal at least one data request associated with data content comprises storing at least one of the following:
login information;
a direct link to the data content;
information associated with at least one data field;
selection information; and
information identifying a communication protocol.

8. A method according to claim 1, characterized in that the method further comprises:
setting up an association between the mobile terminal and the remote computer;
browsing data provided by the data content server of the data communication network using the mobile terminal via the remote computer using the set up association;
sending at least one data request from the mobile terminal via the remote computer to the data content server;
sending at least one data request response from the data content server to the mobile terminal via the remote computer;
receiving with the remote computer a command from the mobile terminal, the command indicating that data content is to be stored in the remote computer;
sending with the remote computer a data content request to the data content server;
sending the data content from the data content server to the remote computer; and
storing the data content in the remote computer.

9. The method according to claim 8, characterized in that the step of setting up an association comprises setting up an association between the mobile terminal and the remote computer using a secure link protocol.

10. The method according to claim 8, characterized in that the method further comprises:
changing a data request for the data content sent by the mobile terminal in the remote computer in order to store the data content in the remote computer.

11. The method according to claim 1, characterized in that the data request sent by the mobile terminal comprise at least one of the following:
login information;
a direct link to the data content;
information associated with at least one data field;
selection information; and
information identifying a communication protocol.

12. A system of storing data content from a data communication network in a remote computer, comprising:
a data communication network (40);
a wireless communication network (42) connected to the data communication network (40);
a data content server (10) connected to the data communication network (40);
a mobile terminal (14) connected to the wireless communication network (42), wherein the mobile terminal (14) comprises browsing means (36) configured to browse data provided by the data content server (10);
a remote computer (12) connected to the data communication network (40);
characterized in that:
the system comprises at least one network device (14, 12) configured to send at least one data request associated with data content to the data content server (10);
the browsing means (36) are configured to select the remote computer (12) connected to the data communication network (40) as a destination device for storing the data content; and
the remote computer (12) is configured to store the data content from the data content server (10).

13. The system according to claim 12, characterized in that:
the browsing means (36) are configured to send at least one data request associated with data content to the data content server (10);
the mobile terminal (14) comprises a first memory (30) configured to store at least one data request associated with the data content;
the browsing means (36) are configured to send at least one data request stored in the first memory (30) to the selected remote computer (12);
the remote computer (12) comprises a remote proxy application (310) configured to receive the at least one data request from the mobile terminal (14), to send at least one data request to the data content server (10), and to receive a requested data content from the data content server (10); and
the remote computer (12) comprises a second memory (302) configured to store the data content.

14. The system according to claim 13, characterized in that the system further comprises:
a connection application (38, 304) configured to set up an association between the mobile terminal (14) and the remote computer (12), wherein the browsing means (36) are configured to send the at least one data request to the remote computer (12) using the set up association.

15. The system according to claim 14, characterized in that the connection application (38, 304) is configured to set up the association between the mobile terminal (14) and the remote computer (12), when the browsing means (36) are used to select the remote computer (12) connected to the data communication network (40) as a destination device for storing the data content.

16. The system according to claim 14, characterized in that the connection application (38, 304) is configured to set up the association between the mobile terminal (14) and the remote computer (12) by using a secure link protocol.

17. The system according to claim 13, characterized in that the remote proxy application (310) is configured to change at least one data request sent by the mobile terminal (14) in order to store the data content in the second memory (302).

18. The system according to claim 13, characterized in that the data requests stored in the first memory (30) comprise at least one of the following:
login information;
a direct link to the data content;
information associated with at least one data field;
selection information; and
information identifying a communication protocol.

19. A system according to claim 12, characterized in that:
the system further comprises a connection application (310) configured to set up an association between the mobile terminal (14) and the remote computer (12);
the browsing means (36) are configured to browse data provided by the data content server (10) using the set up association;
the browsing means (36) are configured to send at least one data request to the data server (10) via a remote proxy application (310) of the remote computer (12);
the remote proxy application (310) is configured to send at least one data request response from the data content server (10) to the mobile terminal (14), to receive a command from the browsing means (36), the command indicating that data content is to be stored in the remote computer (12), to send a data content request to the data content server (10), and to receive the requested data content from the data content server (10); and
the remote computer (12) comprises a second memory (302) configured to store the data content.

20. The system according to claim 19, characterized in that the connection application (38, 304) is configured to set up the association between the mobile terminal (14) and the remote computer (12) by using a secure link protocol.

21. The system according to claim 19, characterized in that the remote proxy application (310) is configured to change at least one data request sent by the mobile terminal (14) in order to store the data content in the second memory (302).

22. The system according to claim 19, characterized in that the data requests sent by the browsing means (36) comprise at least one of the following:
login information;
a direct link to the data content;
information associated with at least one data field;
selection information; and
information identifying a communication protocol.

23. A computer program of storing data content from a data communication network in a remote computer,
characterized in that the computer program comprises code adapted to perform the following steps when executed on a data-processing device:
browsing data provided by a data content server of the data communication network using a mobile terminal;
storing in a memory of the mobile terminal at least one data request associated with data content;
selecting with the mobile terminal a remote computer connected to the data communication network as a destination device for storing the data content; and
sending at least one data request stored in the memory of the mobile terminal to the selected remote computer.

24. The computer program according to claim 23, characterized in that the computer program is further adapted to perform the following steps when executed on the data-processing device:
setting up an association between the mobile terminal and the remote computer; and
sending with the mobile terminal the at least one data request to the remote computer using the set up association.

25. The computer program according to claim 24, characterized in that the computer program is further adapted to perform the following step when executed on the data-processing device:
setting up the association between the mobile terminal and the remote computer, when selecting the remote computer with the mobile terminal.

26. The computer program according to claim 24, characterized in that the computer program is further adapted to perform the following step when executed on the data-processing device:
setting up the association between the mobile terminal and the remote computer using a secure link protocol.

27. The computer program according to claim 23, characterized in that the computer program is further adapted to perform the following step when executed on the data-processing device:
storing in a memory of the mobile terminal at least one data request associated with data content comprises storing at least one of the following:
login information;
a direct link to the data content;
information associated with at least one data field;
selection information; and
information identifying a communication protocol.

28. A computer program of storing data content from a data communication network in a remote computer,
characterized in that the computer program comprises code adapted to perform the following steps when executed on a data-processing device:
setting up an association between a mobile terminal and the remote computer;
browsing data provided by a data content server of the data communication network using the mobile terminal via the remote computer using the set up association;
sending at least one data request from the mobile terminal to the remote computer;
receiving at least one data request response from the remote computer; and
sending a command from the mobile terminal to the remote computer, the command indicating that data content is to be stored in the remote computer.

29. The computer program according to claim 28, characterized in that the computer program is further adapted to perform the following step when executed on the data-processing device:
setting up the association between the mobile terminal and the remote computer using a secure link protocol.

30. The computer program according to claim 28, characterized in that the data requests sent by the mobile terminal comprise at least one of the following:
login information;
a direct link to the data content;
information associated with at least one data field;
selection information; and
information identifying a communication protocol.

31. A computer program of storing data content from a data communication network in a remote computer,
characterized in that the computer program comprises code adapted to perform the following steps when executed on a data-processing device:
setting up an association between a mobile terminal and the remote computer;
receiving at least one data request from the mobile terminal with the remote computer;
sending from the remote computer at least one data request to the data content server;
receiving a requested data content from the data content server with the remote computer; and
storing the data content in the remote computer.

32. The computer program according to claim 31, characterized in that the computer program is further adapted to perform the following step when executed on the data-processing device:
changing at least one data request sent by the mobile terminal in the remote computer in order to store the data content in the remote computer.

33. The computer program according to claim 31, characterized in that the data requests sent by the mobile terminal comprise at least one of the following:
login information;
a direct link to the data content;
information associated with at least one data field;
selection information; and
information identifying a communication protocol.

34. A computer program of storing data content from a data communication network in a remote computer,
characterized in that the computer program comprises code adapted to perform the following steps when executed on a data-processing device:
setting up an association between a mobile terminal and the remote computer;
receiving at least one data request from the mobile terminal with the remote computer;
sending the at least one data request to a data content server;
receiving at least one data request response from the data content server with the remote computer;
sending the at least one data request response to the mobile terminal from the remote computer;
receiving with the remote computer a command from the mobile terminal, the command indicating that data content is to be stored in the remote computer;
sending with the remote computer a data content request to the data content server; and
storing the data content in the remote computer.

35. The computer program according to claim 34, characterized in that the computer program is further adapted to perform the following step when executed on the data-processing device:
setting up an association between the mobile terminal and the remote computer using a secure link protocol.

36. The computer program according to claim 34, characterized in that the computer program is further adapted to perform the following step when executed on the data-processing device:
changing a data request for the data content sent by the mobile terminal in the remote computer in order to store the data content in the remote computer.

37. The computer program according to claim 34, characterized in that the data requests sent by the mobile terminal comprise at least one of the following:
login information;
a direct link to the data content;
information associated with at least one data field;
selection information; and
information identifying a communication protocol.

38. A mobile terminal of storing data content from a data communication network in a remote computer, comprising:
browsing means (36) configured to browse information provided by a data content server (10), wherein the browsing means (36) are configured to send at least one data request associated with data content to the data content server and to receive at least one data request response from the data content server;
characterized in that:
the mobile terminal (14) comprises a first memory (30) configured to store at least one data request associated with data content; and
the browsing means (36) are configured to select the remote computer (12) as a destination device for storing the data content and to send at least one data request stored in the first memory (30) to the selected remote computer (12).

39. The mobile terminal according to claim 38, characterized in that the mobile terminal further comprises:
a connection application (38) configured to set up an association between the mobile terminal (14) and the remote computer (12), wherein the browsing means (36) are configured to send the at least one data request to the remote computer (12) using the set up association.

40. The mobile terminal according to claim 38, characterized in that the connection application (38) is configured to set up the association between the mobile terminal (14) and the remote computer (12), when the browsing means (36) are used to select the remote computer (12) as a destination device for storing the data content.

41. The mobile terminal according to claim 40, characterized in that the connection application (38) is configured to set up the association between the mobile terminal (14) and the remote computer (12) by using a secure link protocol.

42. The mobile terminal according to claim 38, characterized in that the data requests stored in the first memory (30) comprise least one of the following:
login information;
a direct link to the data content;
information associated with at least one data field;
selection information; and
information identifying a communication protocol.

43. A mobile terminal of storing data content from a data communication network in a remote computer, comprising:
browsing means (36) configured to browse information provided by a data content server (10);
characterized in that:
the mobile terminal (14) further comprises a connection application (38) configured to set up an association between the mobile terminal (14) and the remote computer (12);
the browsing means (36) are configured to browse data provided by the data content server (10) via a remote proxy application (310) of the remote computer (12) by using the set up association, to send at least one data request to the remote computer (12), to receive at least one data request response from the remote computer (12), and to send a command to the remote computer (12), the command indicating that data content is to be stored in the remote computer (12).

44. The mobile terminal according to claim 43, characterized in that the connection application (38) is configured to set up the association between the mobile terminal (14) and the remote computer (12) by using a secure link protocol.

45. The mobile terminal according to claim 43, characterized in that the data requests sent by the mobile terminal comprise least one of the following:
login information;
a direct link to the data content;
information associated with at least one data field;
selection information; and
information identifying a communication protocol.

46. A remote computer for storing data content from a data communication network,
characterized in that the remote computer comprises:
a connection application (304) configured to set up an association between a mobile terminal (14) and the remote computer (12);
a remote proxy application (310) configured to receive at least one data request from the mobile terminal (14), to send at least one data request to a data content server (10), and to receive a requested data content from the data content server (10); and
a second memory (302) configured to store the data content.

47. The remote computer according to claim 46, characterized in that the connection application (304) is configured to set up the association between the mobile terminal (14) and the remote computer (12) by using a secure link protocol.

48. The remote computer according to claim 46, characterized in that the remote proxy application (310) is configured to change at least one data request sent by the mobile terminal (14) in order to store the data content in the second memory (302).

49. The remote computer according to claim 46, characterized in that the data requests sent by the mobile terminal (14) comprise at least one of the following:
login information;
a direct link to the data content;
information associated with at least one data field;
selection information; and
information identifying a communication protocol.

50. A remote computer for storing data content from a data communication network,
characterized in that the remote computer comprises:
a connection application (304) configured to set up an association between a mobile terminal (14) and the remote computer (12);
a remote proxy application (310) configured to receive at least one data request from the mobile terminal (14), to send the at least one data request to a data content server (10), to receive at least one data request response from the data content server (10), to send the at least one data request response to the mobile terminal (14), to receive a command from the mobile terminal (14), the command indicating that data content is to be stored in the remote computer (12), to send a data content request to the data content server (10), and to receive the data content from the data content server (10); and
a second memory (302) configured to store the data content from the data content server (10).

51. The remote computer according to claim 50, characterized in that the connection application (304) is configured to set up the association between the mobile terminal (14) and the remote computer (12) by using a secure link protocol.

52. The remote computer according to claim 50, characterized in that the remote proxy application (304) is configured to change at least one data request sent by the mobile terminal (14) in order to store the data content in the second memory (302).

53. The remote computer according to claim 50, characterized in that the data requests sent by the mobile terminal (14) comprise at least one of the following:
login information;
a direct link to the data content;
information associated with at least one data field;
selection information; and
information identifying a communication protocol.
